(19) United States
(12) Patent Application Publication
(10) Pub. No.: US 2007/0216682 A1
(43) Pub. Date: Sep. 20, 2007

(54) Method and apparatus for displaying three dimensions of data in a trend plot

(75) Inventors: Roman Navratil, Prague (CZ); Jiri Rojicek, Prague (CZ)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/375,870

(22) Filed: Mar. 15, 2006

(51) Int. Cl. G06T 11/20

(52) U.S. Cl. 345/440

(57) ABSTRACT

A trend plot showing the trend of one variable or characteristic as a function of a second variable or characteristic on an trend graph is enhanced by displaying information about a third variable of a continuous nature by means of continuously varying the shade or color of the background on which the trend graph is displayed. In one embodiment of the invention, this third variable is represented by chart background color gradient.

### FIELD OF THE INVENTION

The invention pertains to the displaying of data and, more particularly, to the displaying of data pertaining to more than two variables in a trend plot.

### BACKGROUND OF THE INVENTION

In manufacturing facilities and other types of plants, assembly lines, and the like, it is common to collect process and other data in order to monitor the performance of the plant, assembly line or other process (hereinafter collectively system). Such data may be collected by one or more sensors disposed throughout the system, and, particularly, within the manufacturing or other equipment. Common type of data include temperature, flow rates, pressures, voltages, currents, velocities, etc. The data may comprise data about the system itself, e.g., temperatures or pressures within certain equipment, or about the product that is being produced by the system, e.g., temperature of a part being manufactured or the pressure of a fluid being manufactured. Such data also may include more complex data about the product that is being produced, such as some type of measure of quality of the product, the number of products per unit time being produced, or even a quality or abnormality factor that can be calculated from other measured phenomena. Merely a few examples of data concerning the properties of a product that one may be interested in, include dopant levels in a semiconductor substrate in an integrated circuit fabrication system, or purity of a chemical in a chemical producing system.

Even further, data of interest may comprise such data as energy consumption in the system, or in a portion of the system, or in a particular piece of equipment in the system.

In fact, relevant data can comprise almost any measurable or computable characteristic of a system or the product that is being produced by a system.

Accordingly, manufacturing plants and other systems usually comprise a number of sensors for collecting data at periodic time intervals or continuously. The data from these sensors is sent to a computer equipped with software for presenting the data collected from the sensors (or computed from the data obtained by the sensors or other sources) in a human readable form so that the persons responsible for the operation of the system can determine important information about the system or the product being produced by the system.

One common technique for displaying data is the use of trend plots, often called x-y plots. A trend plot is an x-y graph in which one variable is plotted on the y axis against another variable on the x axis. It is very common for the x axis to represent time in a trend plot. However, it need not be time. The variable plotted on the y axis can be any data variable, such as temperature, pressure, flow rate, etc.

The trend plot may be displayed on a computer monitor screen and/or may be printed out on paper. FIG. 1 is an exemplary trend plot simultaneously showing eight different process variables plotted against time. All eight variables are plotted against the same single time scale on the x axis. In the particular example illustrated in FIG. 1, the uppermost plot 12 pertains to a discrete (or categorical) variable having two possible values (e.g., on-off). In this particular example, the variable represented in plot 12 is whether the product being produced did or did not meet a certain quality criterion, such as a minimum dopant level for a semiconductor substrate. The seven remaining variables represented by lines 14, 16, 18, 20, 22, 24, and 26 are all temperatures taken at different locations in the system.

It is common to generate trend plots showing multiple variables simultaneously plotted against the same x-axis variable, as shown in FIG. 1. Trend plots can be very useful to the users of systems in terms of helping them understand how certain variables or characteristics of the system affect other variables or characteristics of the system or the product that it is producing. For instance, it is readily apparent in the trend plot of FIG. 1 that those instances where the product quality became unacceptable as illustrated by areas 27, 28, 29, 30, 31, and 32 in uppermost plot 12 seem to correlate somewhat with the temperature spikes measured in plots 14, 18, 22 and/or 24.

However as is also apparent from FIG. 1, the data in the trend plot is not conclusive as to exactly how the temperature spikes detected by any one of the corresponding temperature sensors correlates to the product quality as illustrated in plot 12. It often is desirable for a plant engineer to be able to see a display that shows information about a third variable on the trend plot. For instance, one may be interested in seeing how the temperature data plotted as a function of time further correlates with another variable, such as pressure. The other variable need not be a completely different variable than those shown on the multiple line trend plot of FIG. 1 but, could, in fact, be one of the other variables already shown in a different line of the same multiple-variable trend plot.

FIG. 2 shows a trend plot in accordance with one attempt in the prior art to display information about a third of variable in an x-y plot. FIG. 2 shows essentially the same trend plot as FIG. 1, except further including highlighted portions 34, 36 of the background of the trend plot. The two highlighted portions offer information about another variable that is not displayed in the trend plot of FIG. 1. The variable is a discrete (or categorical) variable having two values, such as on-spec./off-spec. or normal situation/abnormal situation. In this example, the white background corresponds to time periods when the discrete variable was in a first condition (on-spec.) and the gray (or highlighted) background corresponds to time periods when that variable was in a second condition (e.g., off spec.).

The display technique shown in FIG. 2 has some value, but is quite limited in its application, at least, because it can only be used to display a two-value categorical characteristic.

Accordingly, it is an object of the present invention to provide an improved method and apparatus for displaying data.

It is another object of the present invention to provide an improved method and apparatus for displaying trend plots.

It is a further object of the present invention to provide an improved method and apparatus for displaying values of a third variable in a trend plot.

### SUMMARY OF THE INVENTION

In accordance with the principles of the present invention, a trend plot showing the trend of one variable or characteristic as a function of a second variable or characteristic on an x-y graph is enhanced by displaying in the trend plot information about a third variable of a continuous nature by means of continuously varying the shade or color of the background on which the x-y graph is displayed in correlation with the value of that third variable. In one embodiment of the invention, this third variable is correlated to color in accordance with the continuously variable spectrum of color of visible light (visible light being continuously variable in color from red to violet as a function of its wavelength). Thus for example, shades of violet would correspond to the lowest values of the variable in question, whereas shades of red would correspond to the highest values of that variable. Shades of blue, green, yellow, and orange would represent values between the lowest and highest to values of that variable. The concept is to have a continuous change in color along the continuum of the visible light spectrum, not discrete colors.

### BRIEF DESCRIPTION OF THE DRAWINGS

FIG. 1 is a diagram illustrating a trend plot showing the trend of a plurality of data variables as a function of time in a trend plot in accordance with the prior art.

FIG. 2 is a diagram illustrating a trend plot showing the trend of a plurality of data variables as a function of time in a trend plot and including information as to a third, categorical variable in accordance with the prior art.

FIG. 3 is a diagram illustrating a trend plot showing the trend of a plurality of data variables as a function of time in a trend plot and including information as to a third, continuous variable in accordance with a first embodiment incorporating the principles of the present invention.

FIG. 4 is a diagram illustrating a trend plot showing the trend of a plurality of data variables as a function of time in a trend plot and including information as to a third, continuous variable in accordance with the principles of the present invention and illustrating further aspects of the present invention.

### DETAILED DESCRIPTION OF THE INVENTION

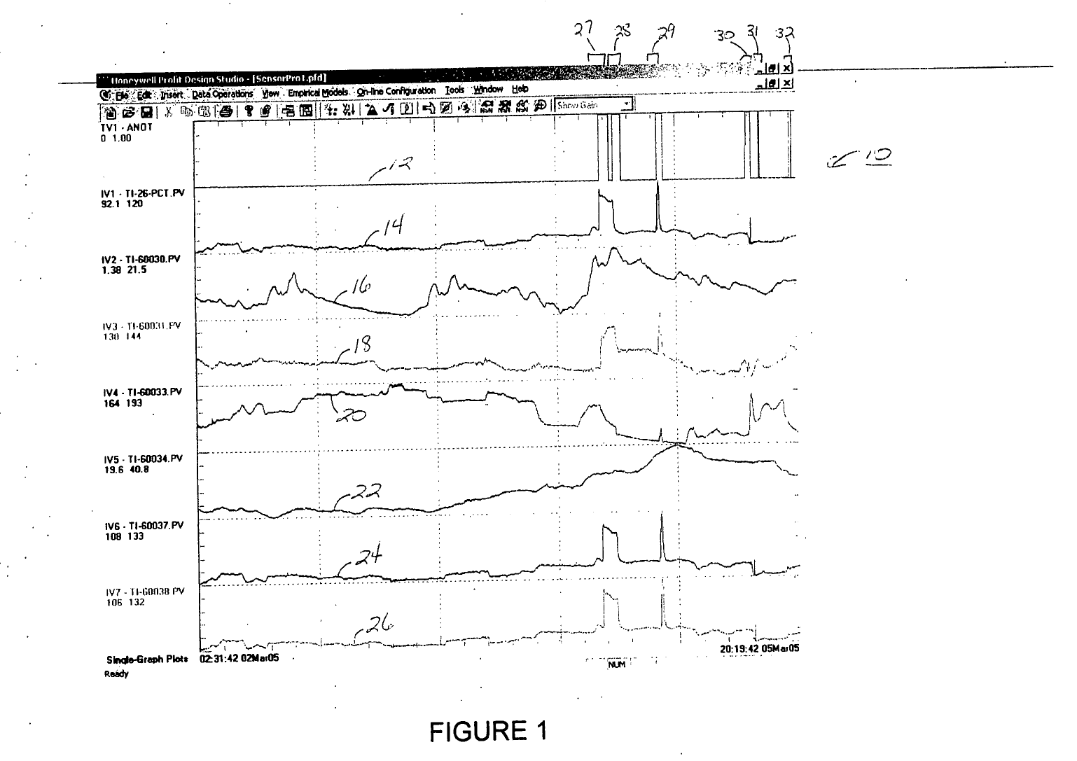

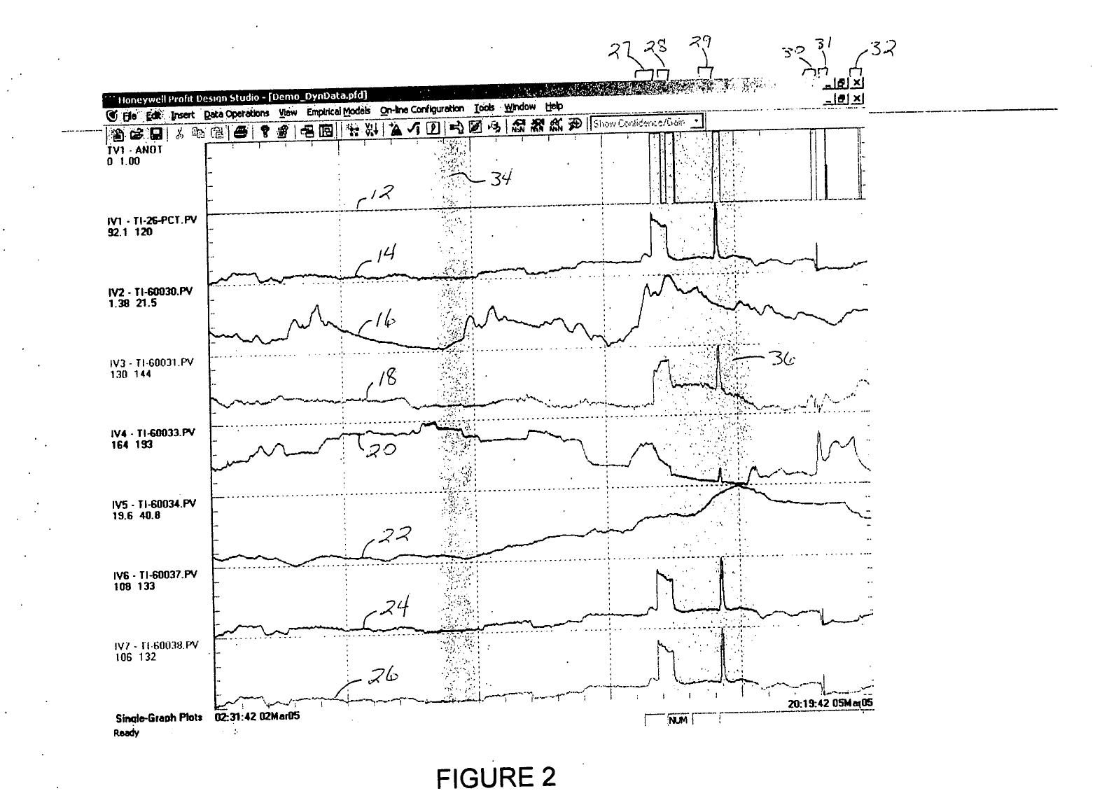

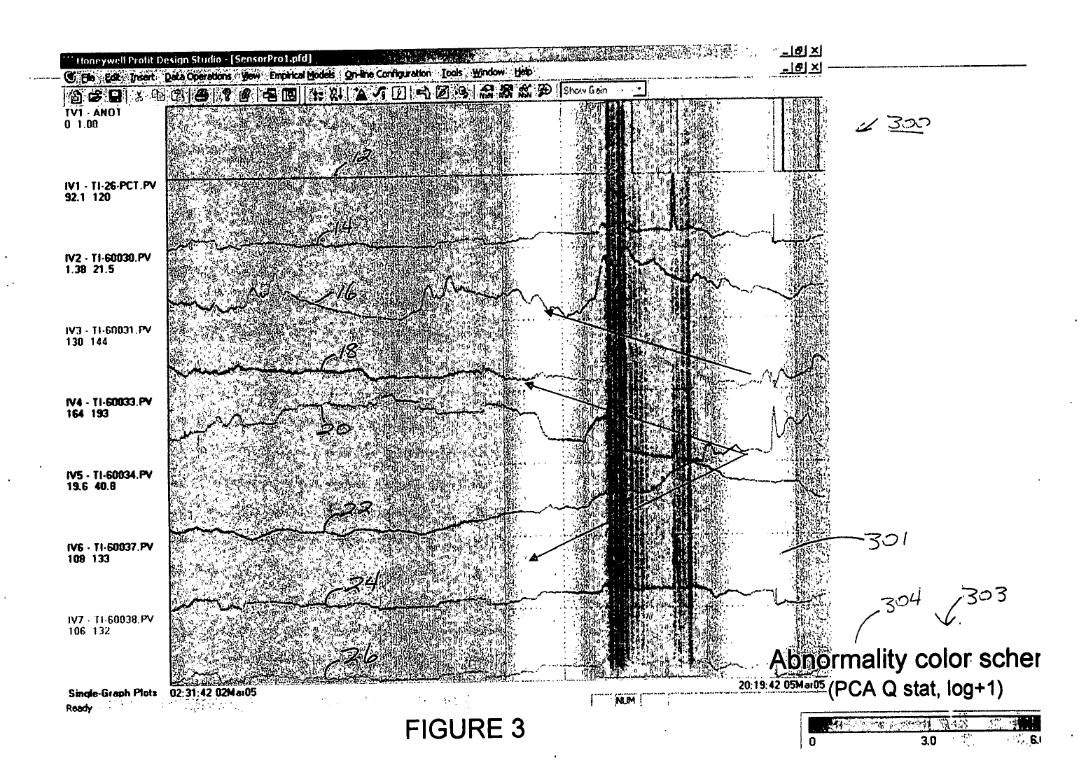

FIG. 3 shows a trend plot 300 that is similar to the ones shown in FIGS. 1 and 2, but including aspects of the present invention. Particularly, the same eight variables are plotted in lines 12, 14, 16, 18, 20, 22, 24, and 26 on the y-axis as a function of time displayed on the x-axis. However, in addition, the color of the background 301 is continuously variable over the full range of the color spectrum as a function of the x-axis. The color is used to represent the value of another, continuous variable. In exemplary FIG. 3, the color of the background represents an abnormality indicator, Q. In this example, the value of Q can range between 0 and 6.0, wherein a value of 0 indicates that the product is exactly on-spec and a value of 6 indicates that the product is very far off-spec.

In this example, the abnormality variable represented by the background color is plotted as a function of time, i.e., the color of the background changes as a function of the position along the x-axis. Also in this particular example, all eight of the variables that are simultaneously plotted against time, as represented by the eight plot lines 12, 14, 16, 18, 20, 22, 24, and 26 also are simultaneously plotted against the same, single abnormality variable represented by the color of the background.

It is well-known that substantial amounts of process information can be made easy to perceive and understand by producing a trend plot like those shown in FIGS. 1, 2 and 3, in which a plurality of variables on the y-axis are plotted against a single variable on the x-axis. This type of multi-line trend plot can provide a significant amount of information quickly and easily to a human observer. The same has been found in connection with the use of background color to represent another variable in connection with a trend plot. That is, adding a single additional variable plotted along the x-axis by means of the background color in connection with a multi-line trend plot can provide a substantial amount of very useful information to the users that is very easily and quickly understandable.

Nevertheless, each individual trend line 12-26 can be individually plotted against a different third variable that is represented by the color of the background. However, presenting such information in a single screen may be counterproductive in that it may place too much information in a single display to be palatable to the observer. Of course, such a problem could be eliminated by showing, in any given display, only a single trend line (or just a few trend lines) plotted against the two variables (e.g., (1) time as represented by the line position in the x-axis dimension and (2) the abnormality value as represented by the background color as a function of the x-axis dimension).

In any event, although there certainly will be exceptions to the following statement, plotting a plurality of y-axis variables as a function of a plurality of different background color variables on the same screen often will simply amount to displaying disjointed information in a single display that provides no particular insight to the user. The biggest advantages envisioned to be provided by the present invention involve plotting a plurality of trend plots against a single third variable so that the users can obtain an easily perceivable and understandable representation of how those plurality of variables correlate to the same third variable.

Furthermore, although FIG. 3 illustrates a preferred embodiment of the invention in which the background color is variable along the x-axis, it is also possible to vary the background color along the y-axis, i.e., the variable represented by the background color is plotted against the variable represented by the y-axis variable, rather than the variable represented by the x-axis.

It will often be preferable to provide a visual indication as to the meaning of the background color. For instance, in the lower right hand corner of FIG. 3 is a key 303 showing what the background color means. Particularly it shows the shades of color scale from blue at the left to red at the right and includes a scale from 0 to 6.0 so that the color can be correlated to the actual abnormality value. Furthermore, in a preferred embodiment of the invention, the name of the variable 304 is shown in or next to the key.

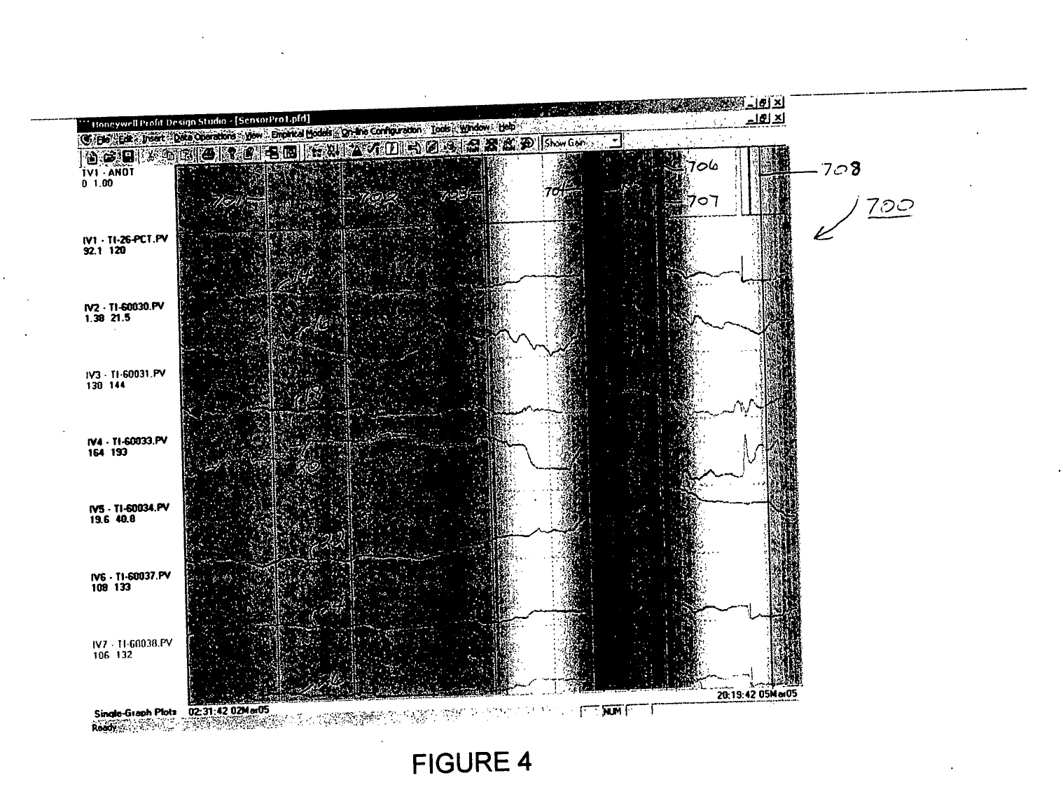

FIG. 4 is a trend plot 700 similar to that shown in FIG. 3, but showing an additional feature in accordance with the principles of the present invention. Particularly demarcation indicators indicating when the third variable crosses a predetermined threshold value have been added. In the embodiment illustrated by FIG. 4, the demarcation indicators are vertical lines 701, 702, 703, 704, 705, 706, 707, and 708. The vertical lines correspond to discrete predetermined threshold values of the variable represented by the background color in which the user has particular interest. For instance, line 701 demarcates the point at which the abnormality variable crossed a threshold of 2.8, line 702 demarcates the point at which the abnormality variable crossed the same threshold of 2.8 (but in the opposite direction, i.e., going from above 2.8 to below 2.8), line 703 demarcates the point at which the abnormality variable crossed a threshold of 3.0, line 704 demarcates the point at which the abnormality variable crossed a threshold of 5.9, line 705 demarcates the point at which the abnormality variable crossed the same threshold of 5.9 (but in the opposite direction as that demarcated by line 705, i.e., going from above to below 5.9), lines 706 and 707 demarcates the same thresholds as lines 704 and 705, respectively, and line 708 demarcates the same threshold as line 702 (namely, crossing from above to below 2.8.

Different colored lines can be used to represent different thresholds, if desired. Alternately, lines having different line styles can indicate different thresholds.

In accordance with another aspect of the present invention, the trend line themselves can have variable color, with the color of the trend lines varying directly inversely to the color of the background. This feature does not add any additional information to the trend plot, but is strictly provided to make the trend line more clearly visible throughout the plots. For instance, if the background were red, the line would be violet and vice versa. Particularly, it is possible that the trend line, if it is dark, may be difficult to see when it is plotted against a dark background color. This feature would solve that problem. This can be made an optional feature so that the user can turn it on or off depending on which option makes the trend plot easier to read in any given instance.

In other contemplated embodiments of the invention, rather than changing the background color, the color of the trend line itself is changed to represent the third variable. In another embodiment, the line thickness or line style can vary to represent the third variable.

It is contemplated that some of the variables that commonly will be useful to plot with the background color in accordance with the present invention include such variables as a measurement or calculated value of data normality, an abnormality indicator, a key performance indicator (KPI), product quality, quality of the input material, and energy price for applications in utilities.

By displaying the additional dimension together with the two dimensional trend plots, a user or engineer can immediately relate this new variable to the trend line behaviors.

Software for generating trend plots from sensor input information is widely available on the market. Adapting such software to include the present invention would be a simple matter of software design. Particularly, it would be desirable to provide some additional graphical user interfaces (GUI) or additional user input parameters on existing GUIs that permit the user to turn the features of the present invention on and off and also to designate which variable is to be plotted by means of the background color.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A computer program product recorded on computer readable medium for generating displays of data, comprising:
computer executable instructions for generating a graph having an x-axis and a y axis on a background and plotting a line representing a first variable represented by a value along the x-axis as a function of a second variable represented by a value along the y-axis; and
computer executable instructions for representing a value of a third variable by continuously varying the color of said background in correlation to said value of said third variable.

2. The computer program product of claim 1 wherein said first variable is time.

3. The computer program product of claim 1 wherein said graph plots a plurality of second variables as a function of said first variable.

4. The computer program product of claim 1 further comprising computer executable instructions for displaying a key illustrating information about said third variable.

5. The computer program product of claim 4 wherein said information about said third variable comprises information disclosing a correlation between said color of said background and a value of said third variable.

6. The computer program product of claim 5 wherein said information about said third variable further comprises the identity of said third variable.

7. The computer program product of claim 1 further comprising computer executable instructions for displaying demarcation indicators indicating when said third variable crosses a predetermined threshold value.

8. The computer program product of claim 7 wherein said demarcation indicator is a line.

9. The computer program product of claim 8 wherein said demarcation indicator comprises a plurality of lines each having a different value for a characteristic, said value of said characteristic of said line representing a particular different threshold value of said third variable.

10. The computer program product of claim 9 wherein said characteristic of said demarcation line is color.

11. The computer program product of claim 9 wherein said characteristic of said demarcation line is line style.

12. The computer program product of claim 1 further comprising computer executable instructions to permit a user to selectively enable said computer executable instructions for representing a value of a third variable.

13. The computer program product of claim 1 further comprising computer executable instructions for causing said line to vary in color inversely to said color of said background.

14. A computer program product recorded on computer readable medium for generating displays of data, comprising:
computer executable instructions for generating a graph having an x-axis and a y axis on a background and plotting a line representing a first variable represented by a value along the x-axis as a function of a second variable represented by a value along the y-axis; and
computer executable instructions for representing a value of a third variable by continuously varying a characteristic of said line in correlation with said value of said third variable.

15. The computer program product of claim 14 wherein said characteristic of said line is color.

16. The computer program product of claim 14 wherein said characteristic of said line is line style.

17. A method for generating displays of data, said method comprising the steps of:
generating a graph having an x-axis and a y axis on a background and plotting a line representing a first variable represented by a value along the x-axis as a function of a second variable represented by a value along the y-axis; and
representing a value of a third variable by continuously varying the color of said background in correlation to said value of said third variable.

18. The method of claim 17 wherein said graph plots a plurality of second variables as a function of said first variable.

19. The method of claim 17 further comprising the step of causing said line to vary in color inversely to said color of said background.

20. The method of claim 17 wherein said step of generating a graph comprises plotting a plurality of second variables as a function of said first and third variables.
